(19) United States
(12) Patent Application Publication
(10) Pub. No.: US 2026/0147566 A1
(43) Pub. Date: May 28, 2026

(54) AUTOMATED FEATURE FLAG REMOVAL IN CODE

(71) Applicant: eBay Inc., San Jose, CA (US)

(72) Inventors: Maximilian Schaum, San Jose, CA (US); Valliappan Thenappan, San Jose, CA (US)

(21) Appl. No.: 18/961,694

(22) Filed: Nov. 27, 2024

(51) Int. Cl. G06F 8/70; G06F 40/279

(52) U.S. Cl. CPC G06F 8/70; G06F 40/279

(57) ABSTRACT

A system is provided that automatically modifies code for an application. The system accesses a database comprising code for an application and generates a prompt comprising instructions for identifying target conditional statements in the code for the application and modifying the code for the application to remove the target conditional statements. The system stores the code for the application in temporary storage. The system processes, by a generative machine learning model, the prompt and the code for the application in the temporary storage to automatically generate a set of new code segments for portions of the code for the application associated with the target conditional statements.

### TECHNICAL FIELD

The subject matter disclosed herein generally relates to a special-purpose machine that includes a system for creating, managing, and deploying software applications, particularly those involving dynamic feature management and controlled rollouts.

### BACKGROUND

Feature flags are a software development technique that allows developers to enable or disable specific functionalities within an application without changing the codebase. While they offer benefits like A/B testing and partial rollouts, feature flags also introduce technical inefficiencies. These inefficiencies include increased resource consumption due to server calls for flag evaluation, added code complexity, accumulation of technical debt, expanded testing requirements, potential performance impacts, and ongoing maintenance burdens.

### BRIEF SUMMARY

In some aspects, the techniques described herein relate to a system including: one or more hardware processors; and at least one machine-storage medium for storing instructions that, when executed by the one or more hardware processors, cause the one or more hardware processors to perform operations including: accessing a database including code for an application; generating a prompt including instructions for identifying target conditional statements in the code for the application and modifying the code for the application to remove the target conditional statements; storing the code for the application in temporary storage; and processing, by a generative machine learning model, the prompt and the code for the application in the temporary storage to automatically generate a set of new code segments for portions of the code for the application associated with the target conditional statements, the set of new code segments for the portions of the code for the application being verified prior to being merged into the code for the application stored in the database.

In some aspects, the techniques described herein relate to a system, wherein the generative machine learning model includes one or more large language models (LLMs), and wherein the target conditional statements include feature flags associated with different features of the application.

In some aspects, the techniques described herein relate to a system, wherein the operations include: generating a first prompt including a first portion of the instructions that define coding for the target conditional statements; and prior to generating the set of new code segments, processing, by the one or more LLMs, the first prompt and the code for the application to identify the portions of the code for the application that match the coding for the target conditional statements.

In some aspects, the techniques described herein relate to a system, wherein the operations for storing the code for the application in the temporary storage include transferring the identified portions of the code for the application that match the coding for the target conditional statements into the temporary storage.

In some aspects, the techniques described herein relate to a system, wherein the operations include prompting an operator to review the set of new code segments; receiving input from the operator confirming validity of the set of new code segments; and merging the set of new code segments with the code for the application stored in the database in response to receiving the input.

In some aspects, the techniques described herein relate to a system, wherein the operations include: generating a second prompt including a second portion of the instructions that specify whether the target conditional statements evaluate to true or false; and processing, by the one or more LLMs, the second prompt and the portions of the code, identified based on the first prompt, stored in the temporary storage to automatically modify the portions of the code into the new code segments based on whether the target conditional statements evaluate to true or false.

In some aspects, the techniques described herein relate to a system, wherein the operations include: determining that a first portion of the identified portions of the code associated with a first target conditional statement that has been specified to evaluate to true; and in response to determining that the first portion of the identified portions of the code is associated with the first target conditional statement that has been specified to evaluate to true, modifying coding for the first target conditional statement that computes a value for the first target conditional statement to cause the first portion of the identified portions of the code to always be executed.

In some aspects, the techniques described herein relate to a system, wherein the operations include: determining that a second portion of the identified portions of the code is associated with a second target conditional statement that has been specified to evaluate to false; and in response to determining that the second portion of the identified portions of the code is associated with the second target conditional statement that has been specified to evaluate to false, automatically modifying coding for the second target conditional statement that computes a value for the second target conditional statement to cause the second portion of the identified portions of the code to never be executed.

In some aspects, the techniques described herein relate to a system, wherein the operations include automatically deleting the second portion of the identified portions from the code for the application.

In some aspects, the techniques described herein relate to a system, wherein the operations include causing a graphical user interface (GUI) to be presented to an operator, the GUI including one or more options for selecting one or more conditional statements as the target conditional statements and a storage location within the database for the code for the application.

In some aspects, the techniques described herein relate to a system, wherein the operations include: causing the GUI to present an option to trigger the generative machine learning model to process the code for the application; and in response to receiving a selection of the option to trigger the generative machine learning model to process the code, generating the prompt and instructing the generative machine learning model to process the code based on the prompt.

In some aspects, the techniques described herein relate to a system, wherein the operations include receiving, via the GUI, input from the operator that defines code segments for the selected one or more conditional statements, the GUI enabling the operator to specify which features of the application have been deployed to all users of the application.

In some aspects, the techniques described herein relate to a system, wherein the operations include monitoring, by the generative machine learning model, the code for the application; and automatically detecting one or more portions of the code for the application associated with target conditional statements.

In some aspects, the techniques described herein relate to a system, wherein the operations include: determining, by the generative machine learning model, that the one or more portions of the code are currently available for access by users of the application; and in response to determining, by the generative machine learning model, that the one or more portions of the code are currently available for access by the users of the application, determining a period of time corresponding to how long the one or more portions of the code have been available for access by the users of the application.

In some aspects, the techniques described herein relate to a system, wherein the operations include: comparing the period of time to a threshold period; and in response to determining that the period of time transgresses the threshold period, automatically processing the prompt by the generative machine learning model to generate the set of new code segments for the one or more portions of the code to remove the target conditional statements associated with the one or more portions of the code.

In some aspects, the techniques described herein relate to a system, wherein the operations include notifying an operator that the one or more portions of the code have been automatically modified by the generative machine learning model.

In some aspects, the techniques described herein relate to a method including: accessing, by one or more hardware processors, a database including code for an application; generating a prompt including instructions for identifying target conditional statements in the code for the application and modifying the code for the application to remove the target conditional statements; storing the code for the application in temporary storage; and processing, by a generative machine learning model, the prompt and the code for the application in the temporary storage to automatically generate a set of new code segments for portions of the code for the application associated with the target conditional statements, the set of new code segments for the portions of the code for the application being verified prior to being merged into the code for the application stored in the database.

In some aspects, the techniques described herein relate to a method, wherein the generative machine learning model includes one or more large language models (LLMs), and wherein the target conditional statements include feature flags associated with different features of the application.

In some aspects, the techniques described herein relate to a method, further including generating a first prompt including a first portion of the instructions that define coding for the target conditional statements; and prior to generating the set of new code segments, processing, by the one or more LLMs, the first prompt and the code for the application to identify the portions of the code for the application that match the coding for the target conditional statements.

In some aspects, the techniques described herein relate to a machine-storage medium for storing instructions that, when executed by one or more hardware processors, cause the one or more hardware processors to perform operations including: accessing a database including code for an application; generating a prompt including instructions for identifying target conditional statements in the code for the application and modifying the code for the application to remove the target conditional statements; storing the code for the application in temporary storage; and processing, by a generative machine learning model, the prompt and the code for the application in the temporary storage to automatically generate a set of new code segments for portions of the code for the application associated with the target conditional statements, the set of new code segments for the portions of the code for the application being verified prior to being merged into the code for the application stored in the database.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some examples.

FIG. 2 is a block diagram illustrating examples of applications that, in one example, are provided as part of a networked system, in accordance with some examples.

FIG. 3 illustrates a conditional statement management platform, in accordance with some examples.

FIG. 4 illustrates a graphical user interface of the conditional statement management platform, in accordance with some examples.

FIG. 5 illustrates a routine for monitoring feature flags, in accordance with some examples.

FIG. 6 is a block diagram illustrating a representative software architecture, which may be used in conjunction with various hardware architectures herein described, in accordance with some examples.

FIG. 7 is a diagrammatic representation of a machine in the form of a computer system within which a set of instructions may be executed for causing the machine to perform any one or more of the methodologies discussed herein, in accordance with some examples.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Feature flags are conditional statements in software that control feature visibility or behavior without requiring code changes. While beneficial for A/B testing and partial rollouts, they introduce technical inefficiencies in several ways. Each flag evaluation typically requires a server call, consuming bandwidth and processing power, which can increase server load and degrade application performance. As the number of flags grows, code complexity increases exponentially, making maintenance, understanding, and debugging more challenging.

Feature flags often become permanent fixtures, contributing to technical debt and requiring ongoing maintenance. The number of possible feature combinations grows with each flag, dramatically increasing the testing surface area and resource requirements. Constant flag evaluation introduces performance overhead, particularly in critical code paths, potentially impacting overall application performance. Ongoing management of feature flags diverts resources from core development tasks, as teams need to track flag usage, purpose, and removal timelines. These factors collectively introduce inefficiencies that can offset the benefits of feature flags, such as in large-scale or high-performance applications. Careful management and strategic implementation are important to mitigate these technical drawbacks and maintain code efficiency.

The present application describes a novel system that addresses these technical challenges, among others, by automatically modifying code for an application that contains feature flags (e.g., conditional statements). The disclosed techniques access a database that includes code for an application and generate a prompt with instructions for identifying target conditional statements in the code for the application. The disclosed techniques modify the code for the application to remove the target conditional statements. Specifically, the disclosed techniques store the code for the application in temporary storage and then process, by a generative machine learning model (e.g., an LLM), the prompt and the code for the application in the temporary storage to automatically generate a set of new code segments for portions of the code for the application associated with the target conditional statements. The set of new code segments for the portions of the code for the application can be verified prior to being merged into the code for the application stored in the database.

As a result, one or more of the methodologies described herein facilitate solving the technical problem of feature flag management presented by conventional methods. As such, one or more of the methodologies described herein may obviate a need for certain efforts or computing resources that otherwise would be involved in managing feature flags (e.g., conditional statements in code). Feature flags can be associated with different features of an application. Application features can include any one or more of user interface elements like dark mode toggles, beta features banners, and custom dashboard widgets, authentication features including multi-factor authentication and social media login options, performance-related features such as caching mechanisms and database query optimizations, integration points with third-party APIs, analytics tracking, and payment gateway options, and/or user permissions including role-based access controls and subscription-level feature access. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

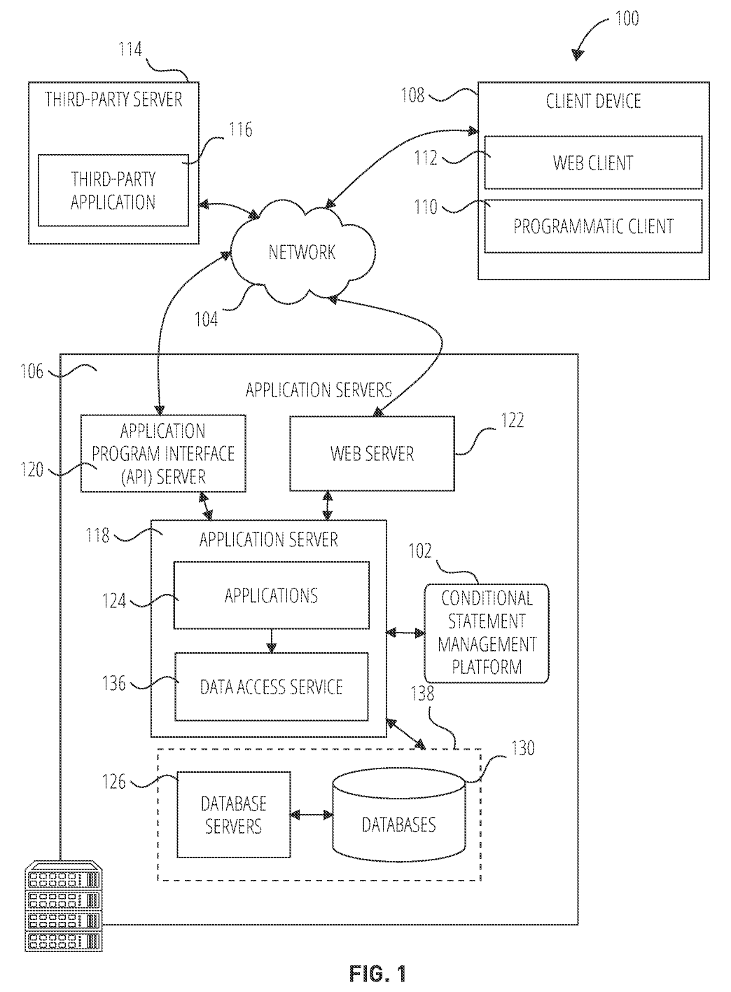

FIG. 1 is a diagrammatic representation of a network environment 100 in which some examples of the present disclosure may be implemented or deployed. One or more application servers 106 provide server-side functionality via a network 104 to a networked user device, in the form of a client device 108. A web client 112 (e.g., a browser) and a programmatic client 110 (e.g., an “app”) are hosted and execute on the web client 112.

An Application Program Interface (API) server 120 and a web server 122 provide respective programmatic and web interfaces to application servers 106. A specific application server 118 hosts an applications 124 and a data access service 136, which includes components, modules and/or applications.

The applications 124 may provide a number of functions and services to users who access the application servers 106. For example, the applications 124 may include a publication application that enables users to publish content (e.g., product item information) on a hosted web page. While the applications 124 is shown in FIG. 1 to be part of the application servers 106, it will be appreciated that, in alternative examples, the applications 124 may be separate and distinct from the application server 118. The applications 124 can also enable buyers to purchase items from an online electronic commerce platform where users can buy and sell physical (tangible) and/or intangible items.

The data access service 136 coordinates requests from the applications 124 to access services provided by conditional statement management platform 102 and to access data stored in one or more cache nodes and/or databases 130 of the data access layer 138. For example, the data access service 136 coordinates transaction requests from the applications 124 across distributed database servers. The conditional statement management platform 102 can track, process, and identify modified code segments 308 of the applications 124 associated with conditional statements (e.g., feature flags). The conditional statement management platform 102 can automatically remove or modify the modified code segments 308 based on whether the conditional statements are determined to be evaluated to TRUE or FALSE. In some cases, the conditional statement management platform 102 can receive or access a prompt that specifies how the conditional statements are defined, such as using example code segments for the conditional statements. The conditional statement management platform 102 can apply an LLM to the application code 206 to identify and retrieve the code segments that are associated with the conditional statements. The conditional statement management platform 102 can then access another prompt that specifies whether the corresponding conditional statements evaluate to TRUE or FALSE. In response to determining that the conditional statements evaluate to TRUE, the conditional statement management platform 102 can generate a set of new code that removes the conditionality of the conditional statements and causes the corresponding code to always be executed without having to first evaluate the conditional statements. The set of new code can be generated by the LLM. In response to determining that the conditional statements evaluate to FALSE, the conditional statement management platform 102 can generate a set of new code that removes the conditionality of the conditional statements and causes the corresponding code to never be executed without having to first evaluate the conditional statements. In some cases, the conditional statement management platform 102 deletes the corresponding code when the conditional statements are determined to be evaluated to FALSE. Again, the set of new code can be generated by the LLM.

Further, while the network environment 100 shown in FIG. 1 employs a client-server architecture, the examples are, of course, not limited to such an architecture, and could equally well find application in a distributed, or peer-to-peer, architecture system. The applications 124 could also be implemented as a standalone software program, which do not necessarily have networking capabilities.

The web client 112 accesses the applications 124 via the web interface supported by the web server 122. Similarly, the programmatic client 110 accesses the various services, microservices, and functions provided by the applications 124 via the programmatic interface provided by the Application Program Interface (API) server 120. In one example, the programmatic client 110 may, for example, be a seller application (e.g., eBay Application developed by eBay Inc., of San Jose, California) to enable sellers to author and manage listings on the network environment 100 in an offline manner, and to perform batch-mode communications between the programmatic client 110 and the application servers 106. In one example, the programmatic client 110 may, for example, be a buyer (purchaser) application (e.g., eBay Application developed by eBay Inc., of San Jose, California) to enable buyers to search available listings for items on the network environment 100 in an online manner, to select items to purchase, and to perform batch-mode communications between the programmatic client 110 and the application servers 106.

FIG. 1 also illustrates a third-party application 116 executing on a third-party server 114 as having programmatic access to the application servers 106 via the programmatic interface provided by the Application Program Interface (API) server 120. For example, the third-party application 116 may, utilizing information retrieved from the application server 118, support one or more features or functions on a website hosted by a third party. The third-party website may, for example, provide one or more promotional, marketplace, or payment functions that are supported by the relevant applications of the application servers 106.

Any of the systems or machines (e.g., databases, devices, servers) shown in, or associated with, FIG. 1 may be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or machines illustrated in FIG. 1 may be combined into a single system or machine, and the functions described herein for any single system or machine may be subdivided among multiple systems or machines. Additionally, any number and types of client device 108 may be embodied within the network environment 100. Furthermore, some components or functions of the network environment 100 may be combined or located elsewhere in the network environment 100. For example, some of the functions of the client device 108 may be embodied at the application server 118.

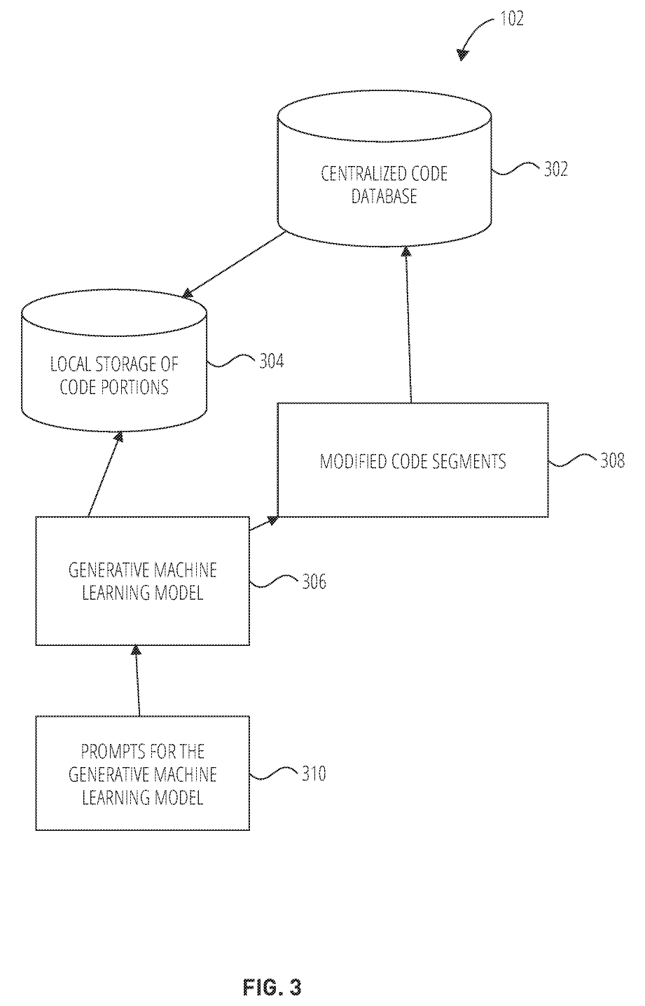

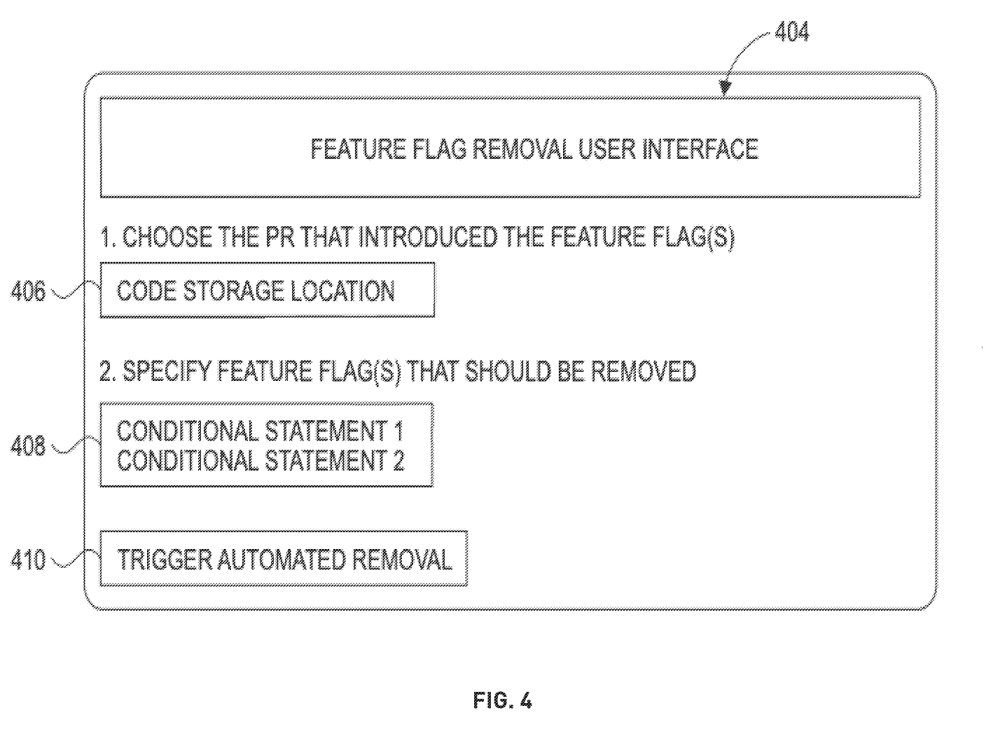

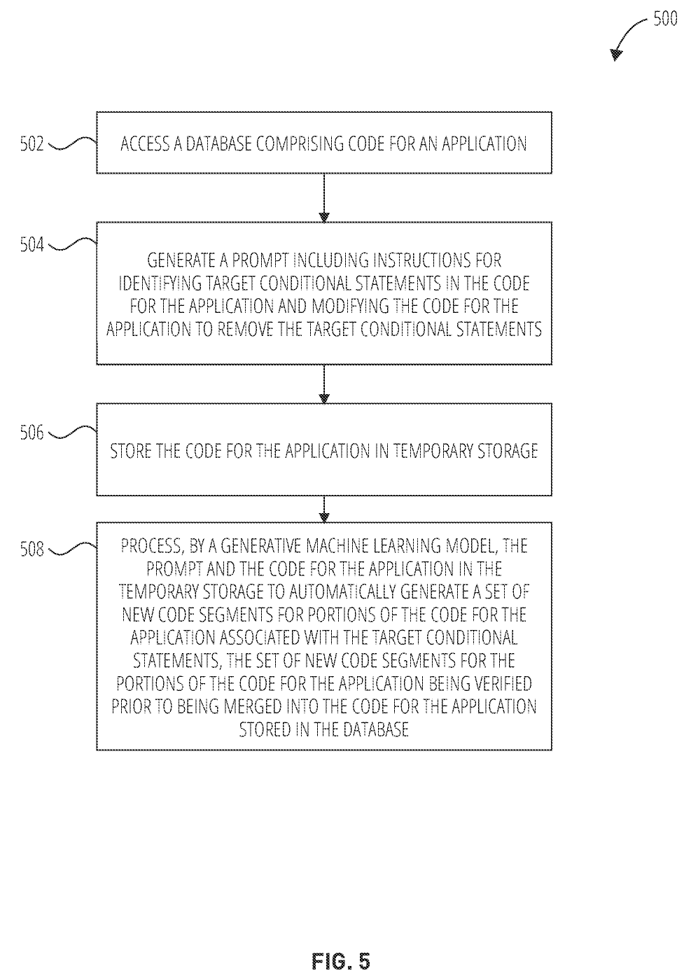

The conditional statement management platform 102 can access a database comprising code for an application and generates a prompt with instructions for identifying target conditional statements in the code for the application and modifying the code for the application to remove the target conditional statements. The conditional statement management platform 102 stores the code for the application in temporary storage (e.g., a local storage device), such as local storage of code portions 304. The conditional statement management platform 102 processes, by a generative machine learning model (e.g., an LLM), the prompt and the code for the application in the temporary storage to automatically generate a set of new code segments for portions of the code for the application associated with the target conditional statements. The set of new code segments for the portions of the code for the application can be verified prior to being merged into the code for the application stored in the databases 130. Further details of the operations and components of the conditional statement management platform 102 are provided below in connection with FIG. 3, FIG. 4 and FIG. 5.

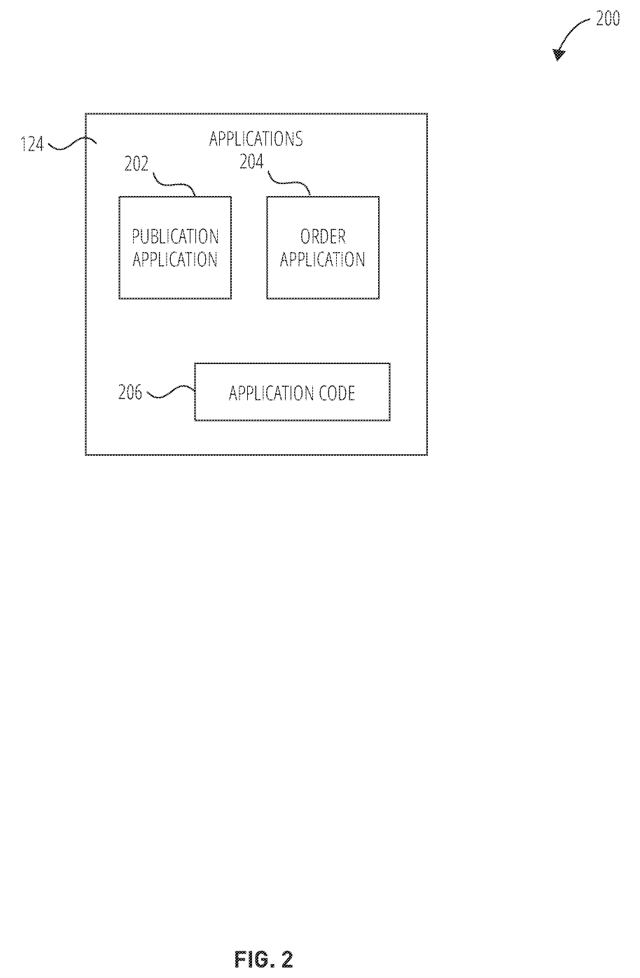

FIG. 2 is a block diagram 200 illustrating the applications 124 that, in one example, are provided as part of the network environment 100. The applications 124 may be hosted on dedicated or shared server machines (not shown) that are communicatively coupled to enable communications between or among server machines. The applications 124 themselves are communicatively coupled (e.g., via appropriate interfaces) to each other and to various data sources, so as to allow information to be passed between or among the applications 124 or so as to allow the applications 124 to share and access common data. The applications 124 may furthermore access one or more databases 130 via the database servers 126.

The application server 118 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the applications 124 is shown to include at least one publication application 202 and one or more order application 204.

In some cases, the applications 124 can provide a graphical user interface (GUI) to a user. The GUI can include an identification of appliances that are owned or associated with the user along with various parts corresponding to each appliance. The GUI can be used by the user to view and/or customize a maintenance schedule for each appliance and/or part. In some cases, the GUI can receive input from the user to add and/or remove one or more appliances from the appliance profile.

The publication application 202 and the order application 204 can be associated with application code 206 that is stored on the databases 130. The databases 130 can be centralized and the conditional statement management platform 102 can process the application code 206 to identify portions of the application code 206 that are associated with conditional statements. The conditional statement management platform 102 can transfer such portions to local storage, such as a temporary storage device on the client device 108. The conditional statement management platform 102 can then further process the portions to generate new code based on whether the conditional statements are determined to be evaluated to always TRUE or always FALSE. The conditional statement management platform 102 can then prompt an operator to verify and review the revised code. In some cases, the revised code can be reviewed by an additional LLM. After receiving confirmation from the operator or from the additional LLM that the revised code is verified, the conditional statement management platform 102 can merge the revised code with the application code 206 stored in the databases 130.

FIG. 3 illustrates a conditional statement management platform 102, in accordance with some examples. As shown in FIG. 3, the conditional statement management platform 102 can include a centralized code database 302, a local storage of code portions 304, and/or a generative machine learning model 306.

The centralized code database 302 can store various codes for multiple applications, such as the application code 206 of FIG. 2. The generative machine learning model 306 can access the prompts for the generative machine learning model 310. Using the prompts for the generative machine learning model 310, the generative machine learning model 306 can select and retrieve a particular code for an application from the centralized code database 302. For example, a graphical user interface 404 can be presented to a user on the client device 108 which allows a user to define various prompts for the generative machine learning model 306. The graphical user interface 404 is shown and described in FIG. 4. In some cases, the centralized code database 302 can represent any one of different forms of input, such as a web user interface, integrated development environment (IDE), API requests, and/or other machine learning models.

Specifically, FIG. 4 illustrates a graphical user interface 404 of the conditional statement management platform 102, in accordance with some examples. The user interface 404 includes various portions and options. The user interface 404 can include a code storage location option 406. The code storage location option 406 can receive input from a user that defines the storage location for code for an application. The storage location can correspond to a storage location on the centralized code database 302. The user interface 404 can also be provided through any one of different forms of input, such as a web user interface, IDE, API requests, and/or other machine learning models.

In some examples, the user interface 404 can include conditional statement options 408. The user interface 404 can receive inputs from a user or operator that selects one or more conditional statements from a list of conditional statements presented in the conditional statement options 408. The conditional statements presented in the conditional statement options 408 can be automatically defined based on an initial processing of the code by the generative machine learning model 306. In some cases, the conditional statement options 408 can be defined manually by one or more operators. Any number of conditional statements can be selected from the conditional statement options 408 to be used as target conditional statements that make up a prompt.

In some examples, once an individual conditional statement is selected from the conditional statement options 408, the user interface 404 can query or prompt the operator to specify whether the conditional statement evaluates to TRUE or FALSE. In some cases, the conditional statement options 408 are automatically selected and automatically determined to evaluate to TRUE or FALSE based on the LLM analyzing usage of the code by users over time, as discussed below. After the conditional statement options 408 are selected and defined by the operator, the user interface 404 can receive input that selects the trigger automated removal option 410. In response to receiving selection of the trigger automated removal option 410, the user interface 404 provides or stores the prompts for the generative machine learning model 310 for access by the generative machine learning model 306.

In some cases, the user interface 404 can receive input from the operator instructing the LLM to automatically search for and identify conditional statements without having such statements selected in the conditional statement options 408.

Referring back to FIG. 3, the generative machine learning model 306 uses the storage location defined by the code storage location option 406 to retrieve one or more codes for one or more applications from the centralized code database 302. The generative machine learning model 306 can store and/or transfer the codes for the one or more applications that have been retrieved in/to the local storage of code portions 304. This can be referred to as the temporary storage of the code segments. After the codes have been moved to the local storage of code portions 304, the generative machine learning model 306 can process that code that is temporarily stored to identify segments associated with the target conditional statements.

In some other cases, the generative machine learning model 306 processes the codes stored on the centralized code database 302 using a first prompt obtained from the prompts for the generative machine learning model 310. The generative machine learning model 306 can use the first prompt to identify those code segments of the code stored on the centralized code database 302 that are associated with the target conditional statements defined by the conditional statement options 408. The generative machine learning model 306 can then store only those retrieved code segments in the local storage of code portions 304.

The generative machine learning model 306 retrieves, from the prompts for the generative machine learning model 310, a prompt indicating whether each target conditional statement evaluates to TRUE or FALSE. The generative machine learning model 306 can identify a portion or segment of code stored in the local storage of code portions 304 that is associated with the target conditional statement. The generative machine learning model 306 can then generate a new set of code for the identified code segments based on whether the associated target conditional statement evaluates to TRUE or FALSE.

For example, the generative machine learning model 306 can determine that a first portion of code corresponding to a first target conditional statement evaluates to TRUE based on the conditional statement options 408. In such cases, the generative machine learning model 306 generates a first set of new code for the first portion of code that replaces the condition of the first target conditional statement with an always TRUE parameter. This causes the corresponding first portion of code to always be executed without having to evaluate the condition for the first target conditional statement. This removes the condition associated with the first target conditional statement. The first set of new code can be stored in the local storage of code portions 304 as the modified code segments 308. After the modified code segments 308 are verified by an operator or an LLM, the first set of new code including the modified code segments 308 is merged or used to modify or replace the corresponding first set of code stored in the centralized code database 302 on the database servers 126 of FIG. 1.

As another example, the generative machine learning model 306 can determine that a second portion of code corresponding to a second target conditional statement evaluates to FALSE based on the conditional statement options 408. In such cases, the generative machine learning model 306 generates a second set of new code for the second portion of code that replaces the condition of the first target conditional statement with an always FALSE parameter. This causes the corresponding first portion of code to never be executed without having to evaluate the condition for the second target conditional statement. This removes the condition associated with the second target conditional statement. In some cases, the second portion of code is marked for deletion in the modified code segments 308 based on determining that the second target conditional statement evaluates to FALSE. The second set of new code can be stored in the local storage of code portions 304 as the modified code segments 308 or the indication to delete the second portion of code can be stored in the local storage of code portions 304. After the first set of new code or indication to delete the second portion of code is verified by an operator or an LLM, the second set of new code is merged or used to modify or replace the corresponding second set of code stored in the centralized code database 302 on the database servers 126. In some cases, in response to determining that the indication to delete is stored in the local storage of code portions 304, the conditional statement management platform 102 automatically deletes the second portion of code from the centralized code database 302 after receiving the confirmation from the operator or LLM.

In some examples, the conditional statement management platform 102 monitors code that is available to users of the network environment 100. The conditional statement management platform 102 can process the code by the LLM to detect segments of the code that are associated with conditional statements. The conditional statement management platform 102 can then measure how long those segments of the code have been available for access by the users. For example, the conditional statement management platform 102 can access a timestamp representing a publication or launch date associated with the detected segments. The conditional statement management platform 102 can compare the timestamp to a current time to measure a period of time representing how long the segments of code have been available for access.

The conditional statement management platform 102 can compare the period of time to a threshold period (e.g., 30 days). The conditional statement management platform 102 can determine whether the period of time transgresses or exceeds the threshold period. In response to determining that the period of time transgresses the threshold period, the conditional statement management platform 102 can automatically process a prompt (e.g., associated with the conditional statements) by the generative machine learning model to generate the set of new code segments for the segments of the code to remove the conditional statements associated with the segments of code. The conditional statement management platform 102 can generate the set of new code segments and store the set of new code segments as the modified code segments 308 in the local storage of code portions 304.

In some examples, the conditional statement management platform 102 can notify or generate a prompt for display to an operator. The prompt or notification can include a snippet of code that includes the original code segments and the generated set of new code segments. The prompt or notification can include an indication that the snippet of code has been determined to be associated with a conditional statement that evaluates to TRUE and has been available for access by the users of the network environment 100 for more than the threshold period of time. In response to receiving input that confirms the modification to the code, the conditional statement management platform 102 can merge the modified code segments 308 with the segments stored in the centralized code database 302 to remove the conditions from the conditional statements associated with the segments of code stored in the centralized code database 302. This improves the overall efficiency of executing code by the conditional statement management platform 102 (or other system component).

FIG. 5 illustrates a routine 500 (e.g., method or process) in accordance with some examples. The operations discussed in connection with FIG. 5 can be performed sequentially, in parallel, and in any suitable order. The operations discussed in FIG. 5 can be performed by the conditional statement management platform 102.

In operation 502, the conditional statement management platform 102 accesses a database comprising code for an application, as discussed above.

In operation 504, the conditional statement management platform 102 generates a prompt including instructions for identifying target conditional statements in the code for the application and modifying the code for the application to remove the target conditional statements, as discussed above.

In operation 506, the conditional statement management platform 102 stores the code for the application in temporary storage, as discussed above.

In operation 508, the conditional statement management platform 102 processes, by a generative machine learning model (e.g., an LLM), the prompt and the code for the application in the temporary storage to automatically generate a set of new code segments for portions of the code for the application associated with the target conditional statements. The set of new code segments for the portions of the code for the application being verified prior to being merged into the code for the application stored in the database, as discussed above.

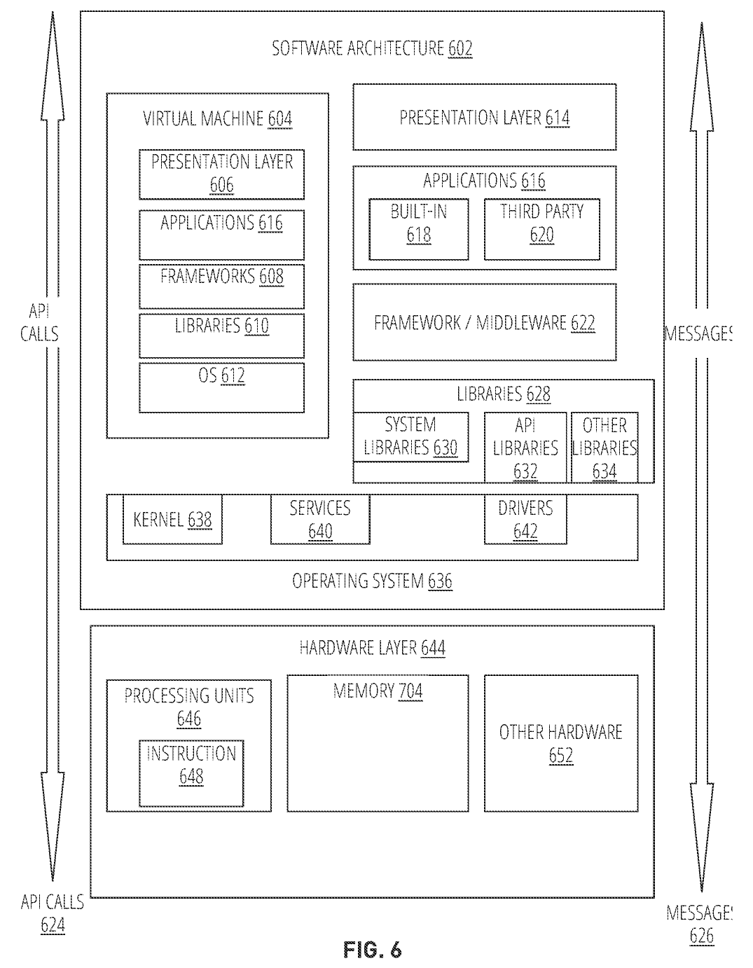

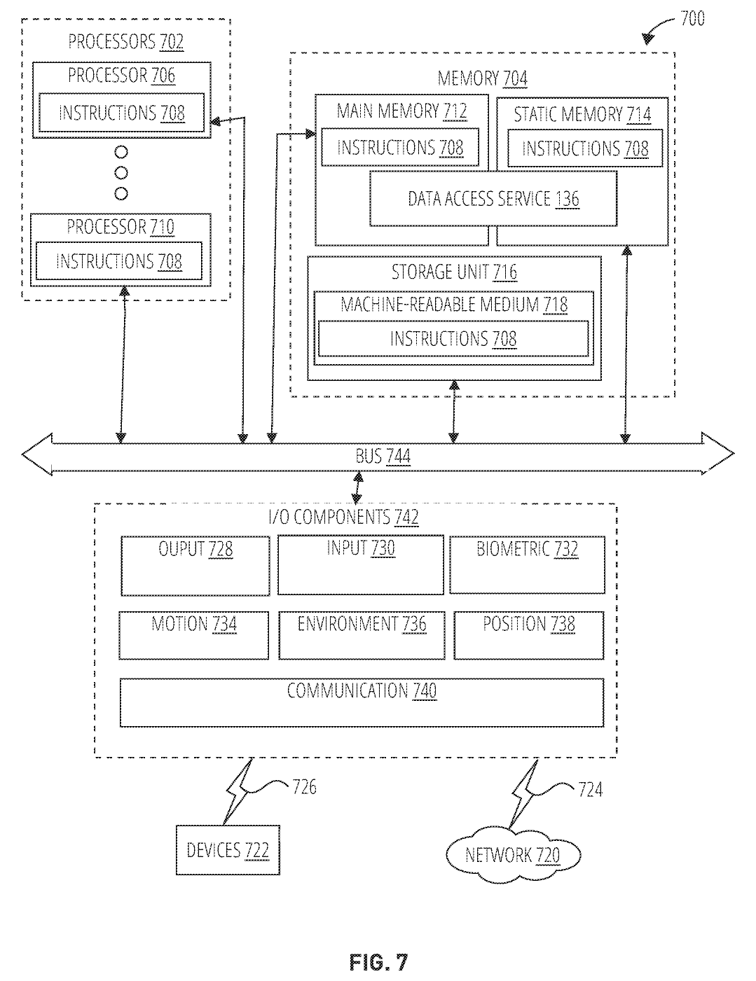

FIG. 6 is a block diagram illustrating an example of a software architecture 602 that may be installed on a machine, according to some examples. FIG. 6 is merely a non-limiting example of a software architecture, and it will be appreciated that many other architectures may be implemented to facilitate the functionality described herein. The software architecture 602 may be executing on hardware such as a machine 700 of FIG. 7 that includes, among other things, processors 710, memory 704, and I/O components 742. A representative hardware layer 644 is illustrated and can represent, for example, the machine 700 of FIG. 7. The representative hardware layer 644 comprises one or more processing units 646 having associated executable instructions 648. The executable instructions 648 represent the executable instructions of the software architecture 602. The hardware layer 644 also includes memory 704, which also have the executable instructions 648. The hardware layer 644 may also comprise other hardware 652, which represents any other hardware of the hardware layer 644, such as the other hardware illustrated as part of the machine 700.

The instructions 648 may be transmitted or received over the network using a transmission medium via a network interface device (e.g., a network interface component included in the communication components 740) and utilizing any one of a number of well-known transfer protocols (e.g., hypertext transfer protocol (HTTP)). Similarly, the instructions 648 may be transmitted or received using a transmission medium via the coupling (e.g., a peer-to-peer coupling) to the devices. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 648 for execution by the machine 700, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” are non-transitory computer-readable media and specifically exclude carrier waves, modulated data signals, and other such media, at least some of which are covered under the term “signal medium.”

In the example architecture of FIG. 6, the software architecture 602 may be conceptualized as a stack of layers, where each layer provides particular functionality. For example, the software architecture 602 may include layers such as an operating system 636, libraries 628, framework / middleware 622, applications 616, and a presentation layer 614. Operationally, the applications 616 or other components within the layers may invoke API calls API calls 624 through the software stack and receive a response, returned values, and so forth (illustrated as messages 626) in response to the API calls 624. The layers illustrated are representative in nature, and not all software architectures have all layers. For example, some mobile or special-purpose operating systems may not provide a framework / middleware 622 layer, while others may provide such a layer. Other software architectures may include additional or different layers.

The operating system 636 may manage hardware resources and provide common services. The operating system 636 may include, for example, a kernel 638, services 640, and drivers 642. The kernel 638 may act as an abstraction layer between the hardware and the other software layers. For example, the kernel 638 may be responsible for memory management, processor management (e.g., scheduling), component management, networking, security settings, and so on. The services 640 may provide other common services for the other software layers. The drivers 642 may be responsible for controlling or interfacing with the underlying hardware. For instance, the drivers 642 may include display drivers, camera drivers, Bluetooth^{®} drivers, flash memory drivers, serial communication drivers (e.g., Universal Serial Bus (USB) drivers), Wi-Fi^{®} drivers, audio drivers, power management drivers, and so forth depending on the hardware configuration.

The libraries 628 may provide a common infrastructure that may be utilized by the applications 616 and/or other components and/or layers. The libraries 628 typically provide functionality that allows other software modules to perform tasks in an easier fashion than by interfacing directly with the underlying operating system 636 functionality (e.g., kernel 638, services 640, or drivers 642). The libraries 628 may include system libraries 630 (e.g., C standard library) that may provide functions such as memory allocation functions, string manipulation functions, mathematic functions, and the like. In addition, the libraries 628 may include API libraries 632 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 628 may also include a wide variety of other libraries 634 to provide many other APIs to the applications 616 and other software components/modules.

The frameworks/middleware 622 (also sometimes referred to as middleware) may provide a higher-level common infrastructure that may be utilized by the applications 616 or other software components/modules. For example, the frameworks/middleware 622 may provide various graphical user interface functions, high-level resource management, high-level location services, and so forth. The frameworks/middleware 622 may provide a broad spectrum of other APIs that may be utilized by the applications 616 and/or other software components/modules, some of which may be specific to a particular operating system or platform.

The applications 616 include built-in applications 618 and/or third-party applications 620. Examples of representative built-in applications 618 may include, but are not limited to, a home application, a contacts application, a browser application, a book reader application, a location application, a media application, a messaging application, or a game application.

The third-party applications 620 may include any of the built-in applications 618, as well as a broad assortment of other applications. In a specific example, the third-party applications 620 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 620 may invoke the API calls 624 provided by the mobile operating system such as the operating system 636 to facilitate functionality described herein.

The applications 616 may utilize built-in operating system functions (e.g., kernel 638, services 640, or drivers 642), libraries (e.g., system libraries 630, API libraries 632, and other libraries 634), or framework / middleware 622 to create user interfaces to interact with users of the system. Alternatively, or additionally, in some systems, interactions with a user may occur through a presentation layer, such as the presentation layer 614. In these systems, the application/module “logic” can be separated from the aspects of the application/module that interact with the user.

Some software architectures utilize virtual machines. In the example of FIG. 6, this is illustrated by a virtual machine 604. The virtual machine 604 creates a software environment where applications/modules can execute as if they were executing on a hardware machine (e.g., the machine 700 of FIG. 7). The virtual machine 604 is hosted by a host operating system (e.g., the operating system 636) and typically, although not always, has a virtual machine monitor, which manages the operation of the virtual machine 604 as well as the interface with the host operating system (e.g., the operating system 636). A software architecture executes within the virtual machine 604, such as an operating system 612, libraries 610, frameworks 608, applications 616, or a presentation layer 606. These layers of software architecture executing within the virtual machine 604 can be the same as corresponding layers previously described or may be different.

FIG. 7 is a diagrammatic representation of the machine 700 within which instructions 708 (e.g., software, a program, an application, an applet, an app, or other executable code) for causing the machine 700 to perform any one or more of the methodologies discussed herein may be executed. For example, the instructions 708 may cause the machine 700 to execute any one or more of the methods described herein. The instructions 708 transform the general, non-programmed machine 700 into a particular machine 700 programmed to carry out the described and illustrated functions in the manner described. The machine 700 may operate as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 708, sequentially or otherwise, that specify actions to be taken by the machine 700. Further, while only a single machine 700 is illustrated, the term “machine” shall also be taken to include a collection of machines that individually or jointly execute the instructions 708 to perform any one or more of the methodologies discussed herein.

The machine 700 may include processors 702, memory 704, and I/O components 742, which may be configured to communicate with each other via a bus 744. In an example, the processors 702 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 706 and a processor 710 that execute the instructions 708. The term “processor” is intended to include multi-core processors that may comprise two or more independent processors (sometimes referred to as “cores”) that may execute instructions contemporaneously. Although FIG. 7 shows multiple processors 702, the machine 700 may include a single processor with a single core, a single processor with multiple cores (e.g., a multi-core processor), multiple processors with a single core, multiple processors with multiples cores, or any combination thereof.

The memory 704 includes a main memory 712, a static memory 714, and a storage unit 716, both accessible to the processors 702 via the bus 744. The main memory 704, the static memory 714, and storage unit 716 store the instructions 708 embodying any one or more of the methodologies or functions described herein. The instructions 708 may also reside, completely or partially, within the main memory 712, within the static memory 714, within machine-readable medium 718 within the storage unit 716, within at least one of the processors 702 (e.g., within the processor’s cache memory), or any suitable combination thereof, during execution thereof by the machine 700.

The I/O components 742 may include a wide variety of components to receive input, provide output, produce output, transmit information, exchange information, capture measurements, and so on. The specific I/O components 742 that are included in a particular machine will depend on the type of machine. For example, portable machines such as mobile phones may include a touch input device or other such input mechanisms, while a headless server machine will likely not include such a touch input device. It will be appreciated that the I/O components 742 may include many other components that are not shown in FIG. 7. In various examples, the I/O components 742 may include output components 728 and input components 730. The output components 728 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 730 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 742 may include biometric components 732, motion components 734, environmental components 736, or position components 738, among a wide array of other components. For example, the biometric components 732 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 734 include acceleration sensor components (e.g., accelerometer), gravitation sensor components, rotation sensor components (e.g., gyroscope), and so forth. The environmental components 736 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 738 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 742 further include communication components 740 operable to couple the machine 700 to a network 720 or devices 722 via a coupling 724 and a coupling 726, respectively. For example, the communication components 740 may include a network interface component or another suitable device to interface with the network 720. In further examples, the communication components 740 may include wired communication components, wireless communication components, cellular communication components, Near Field Communication (NFC) components, Bluetooth^{®} components (e.g., Bluetooth^{®} Low Energy), Wi-Fi^{®} components, and other communication components to provide communication via other modalities. The devices 722 may be another machine or any of a wide variety of peripheral devices (e.g., a peripheral device coupled via a USB).

Moreover, the communication components 740 may detect identifiers or include components operable to detect identifiers. For example, the communication components 740 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as location via Internet Protocol (IP) geolocation, location via Wi-Fi® signal triangulation, location via detecting an NFC beacon signal that may indicate a particular location, and so forth.

The various memories (e.g., memory 704, main memory 712, static memory 714, and/or memory of the processors 702) and/or storage unit 716 may store one or more sets of instructions and data structures (e.g., software) embodying or used by any one or more of the methodologies or functions described herein. These instructions (e.g., the instructions 708), when executed by processors 702, cause various operations to implement the disclosed examples.

The instructions 708 may be transmitted or received over the network 720, using a transmission medium, via a network interface device (e.g., a network interface component included in the communication components 740) and using any one of a number of well-known transfer protocols (e.g., hypertext transfer protocol (HTTP)). Similarly, the instructions 708 may be transmitted or received using a transmission medium via the coupling 726 (e.g., a peer-to-peer coupling) to the devices 722.

Although examples have been described, it will be evident that various modifications and changes may be made to these examples without departing from the broader scope of the present disclosure. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

In view of the disclosure above, various examples are set forth below. It should be noted that one or more features of an example, taken in isolation or combination, should be considered within the disclosure of this application.

Example 1. A system comprising: one or more hardware processors; and at least one machine-storage medium for storing instructions that, when executed by the one or more hardware processors, cause the one or more hardware processors to perform operations comprising: accessing a database comprising code for an application; generating a prompt comprising instructions for identifying target conditional statements in the code for the application and modifying the code for the application to remove the target conditional statements; storing the code for the application in temporary storage; and processing, by a generative machine learning model, the prompt and the code for the application in the temporary storage to automatically generate a set of new code segments for portions of the code for the application associated with the target conditional statements.

Example 2. The system of Example 1, wherein the generative machine learning model comprises one or more large language models (LLMs), and wherein the target conditional statements comprise feature flags associated with different features of the application, the set of new code segments for the portions of the code for the application being verified prior to being merged into the code for the application stored in the database.

Example 3. The system of Example 2, wherein the operations comprise: generating a first prompt comprising a first portion of the instructions that define coding for the target conditional statements; and prior to generating the set of new code segments, processing, by the one or more LLMs, the first prompt and the code for the application to identify the portions of the code for the application that match the coding for the target conditional statements.

Example 4. The system of Example 3, wherein the operations for storing the code for the application in the temporary storage comprise: transferring the identified portions of the code for the application that match the coding for the target conditional statements into the temporary storage.

Example 5. The system of Example 4, wherein the operations comprise: prompting an operator to review the set of new code segments; receiving input from the operator confirming validity of the set of new code segments; and merging the set of new code segments with the code for the application stored in the database in response to receiving the input.

Example 6. The system of any one of Examples 3-5, wherein the operations comprise: generating a second prompt comprising a second portion of the instructions that specify whether the target conditional statements evaluate to true or false; and processing, by the one or more LLMs, the second prompt and the portions of the code, identified based on the first prompt, stored in the temporary storage to automatically modify the portions of the code into the new code segments based on whether the target conditional statements evaluate to true or false.

Example 7. The system of Example 6, wherein the operations comprise: determining that a first portion of the identified portions of the code is associated with a first target conditional statement that has been specified to evaluate to true; and in response to determining that the first portion of the identified portions of the code is associated with the first target conditional statement that has been specified to evaluate to true, modifying coding for the first target conditional statement that computes a value for the first target conditional statement to cause the first portion of the identified portions of the code to always be executed.

Example 8. The system of Example 7, wherein the operations comprise: determining that a second portion of the identified portions of the code is associated with a second target conditional statement that has been specified to evaluate to false; and in response to determining that the second portion of the identified portions of the code is associated with the second target conditional statement that has been specified to evaluate to false, automatically modifying coding for the second target conditional statement that computes a value for the second target conditional statement to cause the second portion of the identified portions of the code to never be executed.

Example 9. The system of Example 8, wherein the operations comprise: automatically deleting the second portion of the identified portions from the code for the application.

Example 10. The system of any one of Examples 1-9, wherein the operations comprise: causing a graphical user interface (GUI) to be presented to an operator, the GUI comprising one or more options for selecting one or more conditional statements as the target conditional statements and a storage location within the database for the code for the application.

Example 11. The system of Example 10, wherein the operations comprise: causing the GUI to present an option to trigger the generative machine learning model to process the code for the application; and in response to receiving a selection of the option to trigger the generative machine learning model to process the code, generating the prompt and instructing the generative machine learning model process the code based on the prompt.

Example 12. The system of any one of Examples 10-11, wherein the operations comprise: receiving, via the GUI, input from the operator that defines code segments for the selected one or more conditional statements, the GUI enabling the operator to specify which features of the application have been deployed to all users of the application.

Example 13. The system of any one of Examples 1-12, wherein the operations comprise: monitoring, by the generative machine learning model, the code for the application; and automatically detecting one or more portions of the code for the application associated with target conditional statements.

Example 14. The system of Example 13, wherein the operations comprise: determining, by the generative machine learning model, that the one or more portions of the code are currently available for access by users of the application; and in response to determining, by the generative machine learning model, that the one or more portions of the code are currently available for access by the users of the application, determining a period of time corresponding to how long the one or more portions of the code have been available for access by the users of the application.

Example 15. The system of Example 14, wherein the operations comprise: comparing the period of time to a threshold period; and in response to determining that the period of time transgresses the threshold period, automatically processing the prompt by the generative machine learning model to generate the set of new code segments for the one or more portions of the code to remove the target conditional statements associated with the one or more portions of the code.

Example 16. The system of Example 15, wherein the operations comprise: notifying an operator that the one or more portions of the code have been automatically modified by the generative machine learning model.

Example 17. A method comprising: accessing, by one or more hardware processors, a database comprising code for an application; generating a prompt comprising instructions for identifying target conditional statements in the code for the application and modifying the code for the application to remove the target conditional statements; storing the code for the application in temporary storage; and processing, by a generative machine learning model, the prompt and the code for the application in the temporary storage to automatically generate a set of new code segments for portions of the code for the application associated with the target conditional statements.

Example 18. The method of Example 17, wherein the generative machine learning model comprises one or more large language models (LLMs), and wherein the target conditional statements comprise feature flags associated with different features of the application.

Example 19. The method of Example 18, further comprising: generating a first prompt comprising a first portion of the instructions that define coding for the target conditional statements; and prior to generating the set of new code segments, processing, by the one or more LLMs, the first prompt and the code for the application to identify the portions of the code for the application that match the coding for the target conditional statements.

Example 20. A machine-storage medium for storing instructions that, when executed by one or more hardware processors, cause the one or more hardware processors to perform operations comprising: accessing a database comprising code for an application; generating a prompt comprising instructions for identifying target conditional statements in the code for the application and modifying the code for the application to remove the target conditional statements; storing the code for the application in temporary storage; and processing, by a generative machine learning model, the prompt and the code for the application in the temporary storage to automatically generate a set of new code segments for portions of the code for the application associated with the target conditional statements.

What is claimed is:

1. A system comprising:
one or more hardware processors; and
at least one machine-storage medium for storing hardware processor instructions that, when executed by the one or more hardware processors, cause the one or more hardware processors to perform operations comprising:
accessing a database comprising code for an application;
generating a prompt comprising instructions for identifying target conditional statements in the code for the application and modifying the code for the application to remove the target conditional statements;
storing the code for the application in temporary storage; and
processing, by a generative machine learning model, the prompt and the code for the application in the temporary storage to automatically generate a set of new code segments for portions of the code for the application associated with the target conditional statements.

2. The system of claim 1, wherein the generative machine learning model comprises one or more large language models (LLMs), and wherein the target conditional statements comprise feature flags associated with different features of the application, the set of new code segments for the portions of the code for the application being verified prior to being merged into the code for the application stored in the database.

3. The system of claim 2, wherein the operations comprise:
generating a first prompt comprising a first portion of the instructions that define coding for the target conditional statements; and
prior to generating the set of new code segments, processing, by the one or more LLMs, the first prompt and the code for the application to identify the portions of the code for the application that match the coding for the target conditional statements.

4. The system of claim 3, wherein the operations for storing the code for the application in the temporary storage comprise:
transferring the identified portions of the code for the application that match the coding for the target conditional statements into the temporary storage.

5. The system of claim 4, wherein the operations comprise:
prompting an operator to review the set of new code segments;
receiving input from the operator confirming validity of the set of new code segments; and
merging the set of new code segments with the code for the application stored in the database in response to receiving the input.

6. The system of claim 3, wherein the operations comprise:
generating a second prompt comprising a second portion of the instructions that specify whether the target conditional statements evaluate to true or false; and
processing, by the one or more LLMs, the second prompt and the portions of the code, identified based on the first prompt, stored in the temporary storage to automatically modify the portions of the code into the new code segments based on whether the target conditional statements evaluate to true or false.

7. The system of claim 6, wherein the operations comprise:
determining that a first portion of the identified portions of the code is associated with a first target conditional statement that has been specified to evaluate to true; and
in response to determining that the first portion of the identified portions of the code is associated with the first target conditional statement that has been specified to evaluate to true, modifying coding for the first target conditional statement that computes a value for the first target conditional statement to cause the first portion of the identified portions of the code to always be executed.

8. The system of claim 7, wherein the operations comprise:
determining that a second portion of the identified portions of the code is associated with a second target conditional statement that has been specified to evaluate to false; and
in response to determining that the second portion of the identified portions of the code is associated with the second target conditional statement that has been specified to evaluate to false, automatically modifying coding for the second target conditional statement that computes a value for the second target conditional statement to cause the second portion of the identified portions of the code to never be executed.

9. The system of claim 8, wherein the operations comprise:
automatically deleting the second portion of the identified portions from the code for the application.

10. The system of claim 1, wherein the operations comprise:
causing a graphical user interface (GUI) to be presented to an operator, the GUI comprising one or more options for selecting one or more conditional statements as the target conditional statements and a storage location within the database for the code for the application.

11. The system of claim 10, wherein the operations comprise:
causing the GUI to present an option to trigger the generative machine learning model to process the code for the application; and
in response to receiving a selection of the option to trigger the generative machine learning model to process the code, generating the prompt and instructing the generative machine learning model to process the code based on the prompt.

12. The system of claim 10, wherein the operations comprise:
receiving, via the GUI, input from the operator that defines code segments for the selected one or more conditional statements, the GUI enabling the operator to specify which features of the application have been deployed to all users of the application.

13. The system of claim 1, wherein the operations comprise:
monitoring, by the generative machine learning model, the code for the application; and
automatically detecting one or more portions of the code for the application associated with target conditional statements.

14. The system of claim 13, wherein the operations comprise:
determining, by the generative machine learning model, that the one or more portions of the code are currently available for access by users of the application; and
in response to determining, by the generative machine learning model, that the one or more portions of the code are currently available for access by the users of the application, determining a period of time corresponding to how long the one or more portions of the code have been available for access by the users of the application.

15. The system of claim 14, wherein the operations comprise:
comparing the period of time to a threshold period; and
in response to determining that the period of time transgresses the threshold period, automatically processing the prompt by the generative machine learning model to generate the set of new code segments for the one or more portions of the code to remove the target conditional statements associated with the one or more portions of the code.

16. The system of claim 15, wherein the operations comprise:
notifying an operator that the one or more portions of the code have been automatically modified by the generative machine learning model.

17. A method comprising:
accessing, by one or more hardware processors, a database comprising code for an application;
generating a prompt comprising instructions for identifying target conditional statements in the code for the application and modifying the code for the application to remove the target conditional statements;
storing the code for the application in temporary storage; and
processing, by a generative machine learning model, the prompt and the code for the application in the temporary storage to automatically generate a set of new code segments for portions of the code for the application associated with the target conditional statements.

18. The method of claim 17, wherein the generative machine learning model comprises one or more large language models (LLMs), and wherein the target conditional statements comprise feature flags associated with different features of the application, the set of new code segments for the portions of the code for the application being verified prior to being merged into the code for the application stored in the database.

19. The method of claim 18, further comprising:
generating a first prompt comprising a first portion of the instructions that define coding for the target conditional statements; and
prior to generating the set of new code segments, processing, by the one or more LLMs, the first prompt and the code for the application to identify the portions of the code for the application that match the coding for the target conditional statements.

20. A machine-storage medium for storing instructions that, when executed by one or more hardware processors, cause the one or more hardware processors to perform operations comprising:
accessing a database comprising code for an application;
generating a prompt comprising instructions for identifying target conditional statements in the code for the application and modifying the code for the application to remove the target conditional statements;
storing the code for the application in temporary storage; and
processing, by a generative machine learning model, the prompt and the code for the application in the temporary storage to automatically generate a set of new code segments for portions of the code for the application associated with the target conditional statements.
